(19) United States
(12) Patent Application Publication
(10) Pub. No.: US 2024/0403606 A1
(43) Pub. Date: Dec. 5, 2024

(54) METHOD AND SYSTEM FOR ESTIMATING OUTPUT UNCERTAINTY FOR DETERMINISTIC ARTIFICIAL NEURAL NETWORK

(71) Applicant: Korea Advanced Institute Of Science And Technology, Daejeon (KR)

(72) Inventors: Sang Wan LEE, Daejeon (KR); Yujin Cha, Daejeon (KR)

(21) Appl. No.: 18/541,962

(22) Filed: Dec. 15, 2023

(30) Foreign Application Priority Data
Jun. 1, 2023 (KR) 10-2023-0071054

(51) Int. Cl. G06N 3/045; G06N 3/084

(52) U.S. Cl. CPC G06N 3/045; G06N 3/084

(57) ABSTRACT

Disclosed is a method and system for estimating output uncertainty of a deterministic artificial neural network (ANN). An output uncertainty estimation method of a deterministic ANN may include generating a dataset by combining training data used for training of a deterministic ANN model and output of the deterministic ANN model trained with the training data; and estimating output uncertainty of the deterministic ANN model based on output for test data of a proxy Gaussian process model trained through the generated dataset.

### CROSS-REFERENCE TO RELATED APPLICATION(S)

This application claims the priority benefit of Korean Patent Application No. 10-2023-0071054, filed on Jun. 1, 2023, in the Korean Intellectual Property Office, the disclosure of which is incorporated herein by reference in its entirety.

### BACKGROUND

### 1. Field of the Invention

Example embodiments relate to a method and system for estimating output uncertainty of a deterministic artificial neural network (ANN).

### 2. Description of the Related Art

In machine learning task, an artificial neural network (ANN) often has high output uncertainty. Although the ANN correctly outputs right away, an amount of error may increase in the future. If uncertainty of a neural network may be estimated and modeled, the reliability of the neural network may be improved and an efficient learning strategy may be established. A probabilistic Bayesian neural network (BNN) may directly measure the uncertainty, but has a bigdata application issue. On the other hand, it is very difficult to measure uncertainty of a deterministic/non-Bayesian neural network (nBNN) widely used for bigdata learning.

Reference material includes Korean Patent Registration No. 10-1456554.

### SUMMARY

Example embodiments may provide an output uncertainty estimation method and system that may indirectly estimate uncertainty of output inherent in a deterministic artificial neural network (ANN), which is most widely used in a machine learning task, using a Gaussian process model.

According to at least one example embodiment, there is provided an output uncertainty estimation method of a computer device including at least one processor, the output uncertainty estimation method including generating, by the at least one processor, a dataset by combining training data used for training of a deterministic ANN model and output of the deterministic ANN model trained with the training data; and estimating, by the at least one processor, output uncertainty of the deterministic ANN model based on output for test data of a proxy Gaussian process model trained through the generated dataset.

According to an aspect, the estimating may include estimating a predictive variance output from the proxy Gaussian process model as the output uncertainty of the deterministic ANN model.

According to another aspect, the variance may be determined through approximation to the output uncertainty of the deterministic ANN model based on equivalence between a Gaussian process model and a probabilistic neural network model and a Bayesian interpretation of a kernel ridge regression (KRR) algorithm.

According to still another aspect, the output uncertainty estimation method may further include training, by the at least one processor, the deterministic ANN model using a first training dataset that includes the training data and an answer label corresponding to the training data.

According to still another aspect, the generating of the dataset may include generating a second training dataset that includes the output of the trained deterministic ANN model by matching the same with the training data as a temporary output label.

According to still another aspect, the output uncertainty estimation method may further include generating, by the at least one processor, the proxy Gaussian process model by training a Gaussian process model with the generated dataset.

According to still another aspect, the generating of the dataset may include transforming the training data in a form of a matrix to an input in a form of a low-dimensional vector for the proxy Gaussian process model when the training data includes image data.

According to still another aspect, the transforming to the input may include transforming the training data for training the proxy Gaussian process model to a feature vector extracted from an intermediate hidden layer of the deterministic ANN model for the training data.

According to still another aspect, the generating of the dataset may include integrating output of a plurality of categories of the deterministic ANN model into one scalar when an output layer of the deterministic ANN model includes a plurality of units.

According to still another aspect, the integrating may include integrating, into one scalar, the output of the plurality of categories of the deterministic ANN model by transforming the output of the deterministic ANN model from a vector expressed through a softmax function to entropy that is a one-dimensional unit value.

According to still another aspect, the deterministic ANN model may include at least one of a classification neural network, a regression neural network, and a generative model.

According to still another aspect, the estimating may include estimating the output uncertainty of the deterministic ANN model based on the output for the test data of the proxy Gaussian process model without modifying a structure of the deterministic ANN model.

According to at least one example embodiment there is provided a computer program stored in a non-transitory computer-readable recording medium to computer-implement the method in conjunction with a computer device.

According to at least one example embodiment there is provided non-transitory computer-readable recording medium storing instructions that, when executed by a processor, cause the processor to perform the method.

According to at least one example embodiment there is provided computer device including at least one processor configured to execute computer-readable instructions, wherein the at least one processor is configured to generate a dataset by combining training data used for training of a deterministic ANN model and output of the deterministic ANN model trained with the training data, and to estimate output uncertainty of the deterministic ANN model based on output for test data of a proxy Gaussian process model trained through the generated dataset.

According to some example embodiments, it is possible to indirectly estimate uncertainty of output inherent in a deterministic ANN, which is most widely used in a machine learning task, using a Gaussian process model.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of an operation algorithm of a Gaussian process model that mimics an original neural network model according to an example embodiment;

FIG. 2 illustrates an example of a relationship between a probabilistic (Bayesian) neural network (indicated as Bernoulli Dropout Neural Networks (BDNN)) and a Gaussian process (GP), and between a deterministic (non-Bayesian) neural network model (nBNN) and a kernel ridge regression (KRR) according to an example embodiment;

FIG. 3 illustrates an example of learning dynamics from phase 0 to phase 3 of a probabilistic (Bayesian) neural network model according to an example embodiment;

FIGS. 4 to 11 are graphs showing examples of actual error (loss) and accuracy in an original convolutional neural network (CNN) model of test data according to prediction uncertainty of a Gaussian process model generated by a deterministic CNN model according to an example embodiment;

FIGS. 12 to 15 are graphs showing examples of actual error (loss) in an original CNN model of test data according to prediction uncertainty of a Gaussian process model generated by a deterministic CNN regression model according to an example embodiment;

FIG. 16 is a graph showing an example of comparing active learning that selects training data according to prediction uncertainty of a Gaussian process model generated by a deterministic CNN model and active learning that selects the training data according to other algorithms according to an example embodiment;

FIG. 17 illustrates an example of comparing a latent vector extracted by a deterministic variational autoencoder (VAE) generation model and an image generation result according to prediction uncertainty of a Gaussian process model of an original VAI model according to an example embodiment;

FIG. 18 is a block diagram illustrating an example of a computer device according to an example embodiment; and

FIG. 19 is a flowchart illustrating an output uncertainty estimation method according to an example embodiment.

### DETAILED DESCRIPTION

Hereinafter, example embodiments will be described with reference to the accompanying drawings.

A machine learning (ML) model refers to a model that probabilistically estimates a distribution (population distribution) to which training data originally belongs using a training dataset that includes a finite number of training data. Due to a characteristic of a method of probabilistically estimating a population distribution, the ML model inevitably faces uncertainty. The uncertainty is quantification of a confidence level at which the ML model makes a decision about new data that the ML model has not learned, that is, has not experienced in the past. Therefore, the uncertainty is defined as a scalar value that has a different value for each ML model and each piece of data. That is, the uncertainty may be interpreted as a function that depends on a model and data.

The uncertainty of the ML model may be defined into various forms depending on its origin, but may be largely classified into two types for practical purposes. A first type is uncertainty caused by data itself (aleatoric uncertainty). This type of uncertainty is uncertainty that arises when it is difficult to accurately verify a population distribution to which data belongs due to noise mixed in the data itself or due to observational limitation that inevitably arises in the process of acquiring data. Uncertainty caused by data is an inherent characteristic that may not be removed after the data is acquired. A second type is uncertainty that arises due to the cause of the ML model (epistemic uncertainty). Uncertainty caused by the model arises when a population distribution is not correctly estimated through data due to a lack of training data located in a specific local distribution to be estimated or due to incompleteness of a learning algorithm. Uncertainty caused by the model is also called Bayesian uncertainty and is a major field of interest in uncertainty research in that the uncertainty may be overcome to some extent by additionally securing training data or by improving the learning algorithm. In example embodiments, the two types of uncertainty are collectively referred to as output uncertainty for convenience.

In practical terms, if uncertainty of a specific ML model for specific data is known, a reliability level of prediction for corresponding data may be determined. In particular, in the case of uncertainty by a model, information is provided to establish an optimal learning strategy of an ML model in a learning environment with limited resources. For example, an ML model that reads medical data on behalf of a doctor may determine prediction uncertainty of input data and may determine whether to make a final decision directly by trusting prediction of the ML model or whether to request additional judgement from an oracle (expert, such as doctor).

However, traditionally, quantifying output uncertainty of an ML model is known to be very challenging. This is because most ML models represent a population distribution of deterministic parameters that do not consider a Bayesian prediction distribution due to its operational characteristic. That is, since a model outputs only a fixed value with a highest expectation value for one input, it is difficult to know the range of various outputs that may appear according to a learning state. In contrast thereto, models particularly designed to directly measure Bayesian uncertainty are called Bayesian models or probabilistic models. That is, since different output is probabilistically sampled even for the same single input, the model may estimate the range in which the output may appear through a plurality of samplings. It may be interpreted that the larger this range, the higher the output uncertainty. However, models capable of probabilistically expressing output are generally very difficult to handle and a training process is complicated, which may make the models be unused for practical purposes. Since data of the real world is defined in a very complex nonlinear distribution, a deep artificial neural network (ANN) model capable of sufficiently expressing the complex nonlinearity is most widely used in modern machine learning issues. However, most practical deep neural network (DNN) models are deterministic models (e.g., non-Bayesian models). That is, most practical high-dimensional ML models have significant limitation that it is difficult to directly measure output uncertainty.

As described above, the example embodiments address new methodology for approximately inferring output uncertainty of a deterministic deep artificial neural network (ANN). Efficiency of uncertainty estimation may be improved by solving issues difficult to solve with the conventional methodology.

The overview and issues of the existing technology that addresses the issues to be solved through the example embodiments are as follows (a) to (d).

(a) There is technology that treats a predictive variance of ensemble acquired by training a plurality of independent deterministic (non-Bayesian) neural network models as estimation uncertainty. Each neural network model may abstract various expression forms for data by learning through cross-validation or by varying hyperparameters. Therefore, it may be interpreted that the more different the prediction results of individual models, the higher the prediction uncertainty of ensemble. However, since a plurality of individual models needs to be generated to generate an ensemble model, significant computational cost is required compared to a single model. Also, since the nature of an issue is fundamentally different from a task of estimating uncertainty of an individual model itself, it is difficult to apply to improving the performance of the model.

(b) A probabilistic neural network refers to a neural network algorithm that represents parameters constituting a neural network model as a probability distribution rather than fixed values. That is, since prediction of the model for data is also probabilistically expressed, output (Bayesian) uncertainty may be additionally expressed. However, the probabilistic neural network model requires vast computing resources for computation and may not be used for a large-scale model accordingly.

(c) Research is being actively conducted on a type of an approximate Bayesian neural network model that enables Bayesian inference while reducing a required computational amount of a probabilistic neural network. A representative method applies a Monte-Carlo dropout technique that randomly blocks connections in a neural network with a certain probability in both learning and inference stages of the neural network. However, the neural network model to which dropout is applied still has disadvantage that learning itself is difficult when a model size increases.

(d) In addition, proposed is a method of using a separate neural network that learns an error of a specific neural network model by considering an output error (loss) of a neural network as a kind of the neural network. However, since a significant number of neural network uncertainty estimation methods require modification of a target neural network or introduction of an additional element only for uncertainty estimation, there is a risk of causing modification of an original design performance or function of the neural network model.

In a machine learning issue, it is very important to model and quantify output uncertainty of an artificial neural network (ANN) model, in order to establish learning strategy and to evaluate prediction of an ANN. The example embodiments address new methodology that may estimate output uncertainty, which is difficult to directly estimate, arising in a deterministic ANN (a most common type of a neural network model that is also referred to as (non-Bayesian) model and outputs the same value at all times when the same value is input), using a Gaussian process model.

An uncertainty estimation method and system of a deterministic neural network according to example embodiments are developed based on the following properties.

(1) A probabilistic artificial neural network (ANN) model may be interpreted as equivalent to a Gaussian process model.

(2) A deterministic (non-probabilistic) ANN model may be interpreted as equivalent to a kernel ridge regression (KRR) model.

(3) Output uncertainty of the KRR model of (2) is the same as an output variance of the Gaussian process model of (1) that is generated using the same kernel and training data as those of the corresponding KRR model.

Integrating the above properties (1) to (3), the output uncertainty inherent within the deterministic neural network may be estimated by generating the Gaussian process model that approximates the corresponding deterministic neural network.

However, in reality, a kernel function that constitutes the neural network model and a kernel function that constitutes the Gaussian process model are defined in different forms. Therefore, it is difficult to generate the Gaussian process model that approximates the original neural network using an analytical method.

The example embodiments draw a conclusion that a predictive variance output from a Gaussian process model, which is generated (trained) through training of a deterministic ANN model and a dataset D paired with training data X used for training and output Y output from the trained model for X, approximates output uncertainty (Bayesian uncertainty) inherent in an original ANN model, although a kernel function of the Gaussian process model and a kernel function inherent in the neural network model differ from each other.

As described above, the example embodiments may indirectly infer uncertainty of a corresponding deterministic neural network by approximating a random deterministic neural network model with a Gaussian process model (a type of a meta model capable of expressing uncertainty and having a simple shape).

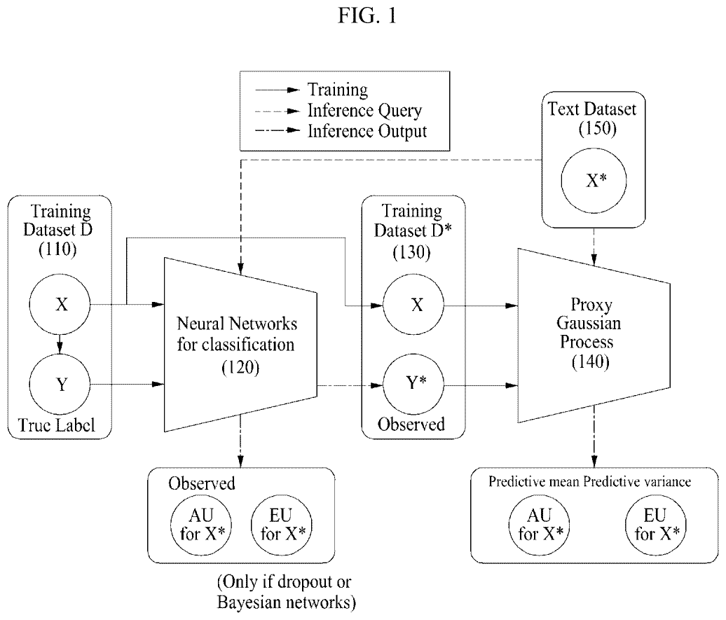

FIG. 1 illustrates an example of an operation algorithm of a Gaussian process model that mimics an original neural network model according to an example embodiment. An output uncertainty estimation method of a deterministic neural network using a Gaussian process according to the example embodiment is as follows 1) to 4).

1) A target neural network (non-probabilistic deterministic neural network) model to estimate uncertainty may be trained using a training dataset D 110. Here, the training dataset D 110 may include a dataset X and an answer label set Y. A target neural network model may correspond to a neural network for classification 120 in the example embodiment of FIG. 1.

2) During a training process, a temporary output label set Y* may be acquired by acquiring output for the training dataset D 110 from the target neural network model that reaches a point at which overfitting starts to occur through a separate validation dataset.

3) A training dataset D* 130 may be constructed by matching X and Y* and a separate Gaussian process model 140 may be generated (trained) by introducing a random kernel function using the training dataset D* 130. Here, the generated Gaussian process model 140 is also referred to as a proxy Gaussian process model.

4) Output uncertainty of the target neural network model that the target neural network model does not directly express for a dataset x* included in a new test dataset 150 may be replaced with a predictive variance (EU for x*) output from the separately generated Gaussian process model 140 for the dataset x*.

The aforementioned procedure of 1) to 4) describes a general procedure and the following modified procedure may be applied to special cases. Data, such as an image, is high-dimensional, resulting in large computational cost, and also in a matrix form, making it difficult for the proxy Gaussian process model 140 to directly receive and process an input. Therefore, the data needs to be transformed to an input in a low-dimensional vector form. Here, the proxy Gaussian process model 140 may be generated with not an original matrix of X that is input to the target neural network model 120 but a feature vector that is extracted from an intermediate hidden layer of the target neural network model 120 for X. It is derived from the assumption that the feature vector acquired from the intermediate hidden layer reflects most of information included in a matrix of an input layer and it is extremely assumed that an input matrix and a feature vector may be regarded as one-to-one correspondence. A deterministic deep neural network (DNN) (representatively, a classification neural network) of which an output layer includes a plurality of units requires additional assumption to deal with uncertainty of the entire neural network. This is because a neural network constructed with a plurality of output units may define an individual KRR models based on the respective individual output units in a direction from each corresponding individual unit to an input layer. For example, since a general classification neural network for classification into M categories includes M output units, M independent KRR models are assumed. This makes it difficult to achieve the invention goal of approximating the uncertainty of a single unit neural network using one proxy Gaussian process model 140. Here, in the case of defining a kernel that integrates output of a neural network having a plurality of output units into one scalar, the neural network model may be treated as the neural network model that outputs the entire unit as one scalar value. For example, output of a classification neural network having a plurality of output units may be transformed from a vector (simplex) expressed through a softmax function to entropy that is a one-dimensional unit value (, which is a different concept from cross-entropy). In that entropy computed from final output of the classification neural network represents uncertainty of data itself (aleatoric uncertainty), a classification neural network model may be regarded as a single regression model. Here, if input data X and output entropy are treated as Y*, the proxy Gaussian process model 140 capable of estimating the output uncertainty of the entire original neural network may be easily generated.

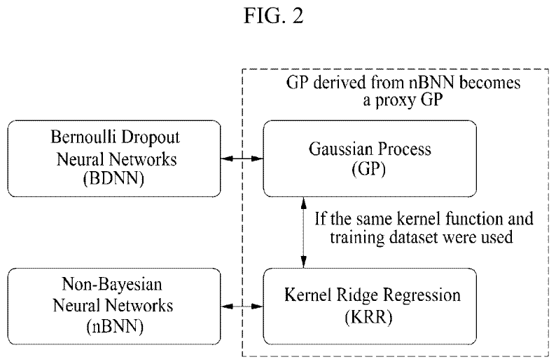

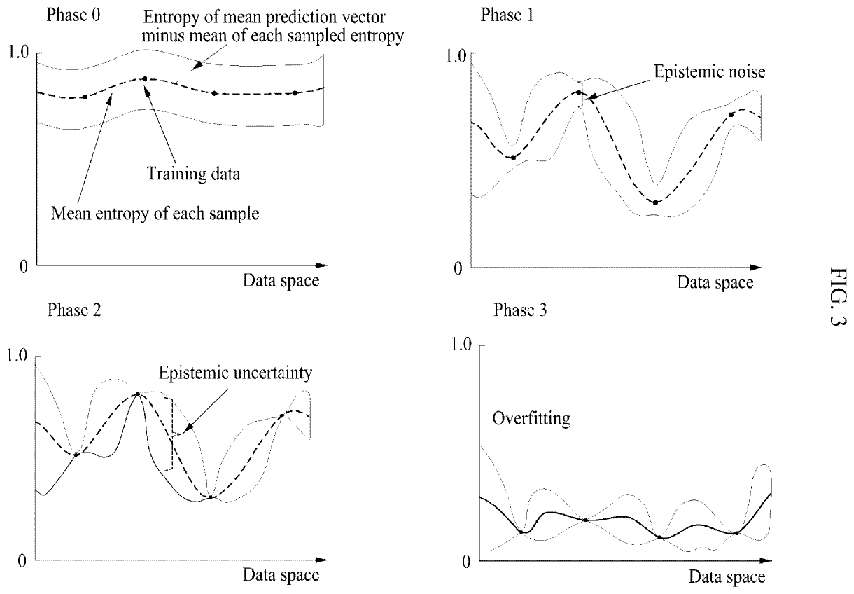

The basic technology that serves as background for the example embodiments is as follows (a to (c. FIG. 2 illustrates an example of a relationship between a probabilistic (Bayesian) neural network (indicated as Bernoulli Dropout Neural Networks (BDNN)) and a Gaussian process (GP), and between a deterministic (non-Bayesian) neural network model (nBNN) and a kernel ridge regression (KRR) according to an example embodiment.

### (a Equivalence Between a Gaussian Process (GP) Model and a Probabilistic (Bayesian) Neural Network Model

A Gaussian process refers to a set of random variables that follow a joint Gaussian distribution for a random dataset when this random dataset is present. The Gaussian process is a type of a random process algorithm characterized by introduction of a kernel and is known as a representative non-parametric machine learning (ML) algorithm that may probabilistically express a specific function itself. A model generated by the Gaussian process is a representative probabilistic (Bayesian) ML model that may express an average and a variance of specific prediction. Unlike this, a neural network that is a representative parametric ML algorithm is a representative algorithm of modern machine learning since it is designed by mimicking a connection structure of biological nerve cells and may express high nonlinearity. The neural network and the Gaussian process are known to be independent algorithms having completely different approach and properties. However, according to the recent research, a Bayesian neural network that probabilistically expresses parameters is equivalent to the Gaussian process under certain conditions. That is, the probabilistic (Bayesian) neural network model is in a complex structure that includes a plurality of hidden layers, but has structural characteristics and functional elements equivalent to a single large Gaussian process model. According to this background, a single Gaussian process model may be theoretically transformed to the neural network model with a Bayesian neural network algorithm, and an opposite transformation may also be performed.

In detail, a process of improving that a single probabilistic (Bayesian) neural network model is equivalent to the Gaussian process model is disclosed. However, in the corresponding research, in the case of a neural network (e.g., classification neural network) having a plurality of output units, the respective independent Gaussian process models are derived based on the output units and the entire neural network model is modeled using a single multivariate Gaussian process. The example embodiments may define a kernel that integrates output into one scalar based on a classification neural network, which is a neural network model having a plurality of output units, with a different analysist perspective, thereby modeling the classification neural network model using a single univariate Gaussian process. The following Equation 1 defines a kernel function corresponding to a Gaussian process model in two input vectors xₑ and x_{f} in a unit hidden layer neural network model having K units.

$$\hat{K} ( {x}_{e} , {x}_{f} ) = \frac{1}{K} {\sum }_{k = 1}^{K} g ( {w}_{( k )}^{⊤} {x}_{e} + {b}_{k} ) g ( {w}_{( k )}^{⊤} {x}_{f} + {b}_{k} ) \qquad [ Equation 1 ]$$

Here, w₍ₖ₎ denotes a connection weight of k^{th} hidden unit and bₖ denotes a deviation value of the k^{th} hidden unit. Function g( ) refers to a nonlinear transformation function and an active function, such as rectifier linear unit (ReLU) and Tanh generally used in a neural network algorithm, may correspond to g( ) Here, if a distribution of output Y of a single hidden layer is indicated by writing a hidden layer that is a set of w with number 1 indicating a first hidden layer as a subscript, it may be represented as the following Equation 2.

$$\begin{matrix}{W}_{1} = {[ {w}_{1 , ( k )} ]}_{k = 1}^{K} , {b}_{1} = {[ {b}_{1 , ( k )} ]}_{k = 1}^{K} , \\ F \vert X , {W}_{1} , {b}_{1} \sim 𝒩 ( 0 , \hat{K} ( X , X ) ) , \\ Y \vert F \sim 𝒩 ( F , {σ}^{- 1} {I}_{N} ) ,\end{matrix} \qquad [ Equation 2 ]$$

Here, X denotes the entire training dataset and σ denotes a parameter that expresses accuracy. If there is an output layer that includes D units (i.e., of a classification neural network for classification into D classes) at an end of a hidden layer, a kernel for expressing the output as one scalar may be defined as an example in Equation 3 below. Here, if it can be expressed as one scalar, various variant kernels may be defined.

$$\begin{matrix}= - \frac{{e}^{g ( {w}_{2 ( d )}^{⊤} {x}_{e} + {b}_{2 ( d )} )}}{{\sum }_{k = 1}^{D} {e}^{g ( {w}_{2 ( k )}^{⊤} {x}_{e} + {b}_{2 ( k )} )}} {log}_{D} \frac{{e}^{g ( {w}_{2 ( d )}^{⊤} {x}_{e} + {b}_{2 ( d )} )}}{{\sum }_{k = 1}^{D} {e}^{g ( {w}_{2 ( k )}^{⊤} {x}_{e} + {b}_{2 ( k )} )}} \\ = - \frac{{e}^{g ( {w}_{2 ( d )}^{⊤} {x}_{f} + {b}_{2 ( d )} )}}{{\sum }_{k = 1}^{D} {e}^{g ( {w}_{2 ( k )}^{⊤} {x}_{f} + {b}_{2 ( k )} )}} {log}_{D} \frac{{e}^{g ( {w}_{2 ( d )}^{⊤} {x}_{f} + {b}_{2 ( d )} )}}{{\sum }_{k = 1}^{D} {e}^{g ( {w}_{2 ( k )}^{⊤} {x}_{f} + {b}_{2 ( k )} )}} \\ ( {x}_{e} , {x}_{f} ) = \frac{1}{D} {\sum }_{d = 1}^{D} \cdot ,\end{matrix} \qquad [ Equation 3 ]$$

Here, w₂ denotes a connection weight of a unit corresponding to the output layer. Final output Y in which the final output is modeled as a Gaussian process may be defined as the following Equation 4.

$$\begin{matrix}{F}_{1} \vert X , {W}_{1} , {b}_{1} \sim 𝒩 ( 0 , ( X , X ) ) , \\ {F}_{2} \vert X , {W}_{2} , {b}_{2} \sim 𝒩 ( 0 , ( {F}_{1} , {F}_{1} ) ) , \\ Y \vert {F}_{2} \sim 𝒩 ( {F}_{2} , {σ}^{- 1} {I}_{N} )\end{matrix} \qquad [ Equation 4 ]$$

### (b Equivalence Between a KRR Model and a Deterministic Neural Network Model

KRR refers to a machine learning (ML) algorithm that acquires nonlinear regression analysis by mapping a variable received as input from a linear regression analysis algorithm using a kernel function. The KRR model refers to a deterministic learning model and outputs a single value (expectation) having a top likelihood for a specific input. If the KRR model is derived through a process similar to (1) above, it can be known that the KRR model is equivalent to a deterministic (non-Bayesian) neural network model. Therefore, a single KRR model may be theoretically transformed and expressed as the deterministic (non-Bayesian) neural network model and an opposite transformation may also be performed.

A KRR algorithm may be derived by replacing an input part of training data with a kernel function in a general linear regression algorithm.

$$y ( {x}_{n} ) = {[ ϕ ( {x}_{n} ) ]}^{⊤} β + {ϵ}_{n} . \qquad [ Equation 5 ]$$

Here, β denotes a K-dimensional vector and Ø denotes a kernel. When N pieces of training data are present, \hat{β} approximated from β with an optimization method may be expressed as the following Equation 6 through a Woodbury matrix approximation and parameter λ by introducing an (N×K)-dimensional matrix Φ=[ϕ(x₁), . . . , ϕ(x_{N})]^{T}.

$$\hat{β} = {( λ {I}_{K} + {Φ}^{⊤} Φ )}^{- 1} {Φ}^{⊤} y = Φ {( λ {I}_{N} + {ΦΦ}^{⊤} )}^{- 1} y \qquad [ Equation 6 ]$$

Through a matrix multiplication method, prediction output y* of the KRR model for new data x* may be arranged as the following Equation 7.

$${y}^{*} ≡ {[ ϕ ( {x}^{*} ) ]}^{⊤} \hat{β} = {[ ϕ ( {x}^{*} ) ]}^{⊤} {( λ {I}_{N} + {ΦΦ}^{⊤} )}^{- 1} y \qquad [ Equation 7 ]$$

If a kernel function for two input vectors xₑ and x_{f} is defined as Equation 8 as follows,

$$\begin{matrix}𝒦 ( {x}_{e} , {x}_{f} ) = 〈 ϕ ( {x}_{e} ) , ϕ ( {x}_{e} ) 〉 , \\ {K}_{ij} = {ϕ ( {x}_{i} )}^{⊤} ϕ ( {x}_{j} ) , \\ k ( x ) = {[ 𝒦 ( x , {x}_{1} ) , … , 𝒦 ( x , {x}_{N} ) ]}^{⊤}\end{matrix} \qquad [ Equation 8 ]$$

y* may be arranged as the following Equation 9.

$${y}^{*} = {[ k ( {x}^{*} ) ]}^{⊤} {( λ {I}_{N} + K )}^{- 1} y \qquad [ Equation 9 ]$$

In the case of defining a kernel function with the aforementioned method that is defined to exhibit the equivalence of the Gaussian process with the Bayesian neural network, a kernel function of the following Equation 10 may be substituted for Equation 7 and Equation 8. In this case, a single deterministic neural network model may be replaced with the KRR model.

$${W}_{2} = {[ {w}_{2 ( k )} ]}_{k = 1}^{D} = {[ {w}_{2 ( d )} ]}_{d = 1}^{D} , {b}_{2} = {[ {b}_{2 ( k )} ]}_{k = 1}^{D} = {[ {b}_{2 ( d )} ]}_{d = 1}^{D} , \qquad [ Equation 10 ]$$

$$ϕ ( x , {W}_{2} , {b}_{2} ) = \sqrt{\frac{1}{D}} \frac{{e}^{δ ( {w}_{2 ( d )}^{⊤} x + {b}_{2 ( d )} )}}{{\sum }_{k = 1}^{D} {e}^{δ ( {w}_{2 ( k )}^{⊤} x + {b}_{2 ( k )} )}} {log}_{D} \frac{{e}^{δ ( {w}_{2 ( d )}^{⊤} x + {b}_{2 ( d )} )}}{{\sum }_{k = 1}^{D} {e}^{δ ( {w}_{2 ( k )}^{⊤} x + {b}_{2 ( k )} )}}$$

### (c Bayesian Interpretation of a KRR Algorithm

A Gaussian process and a KRR algorithm are derived through different processes, respectively, but have in common that prediction (output of a model) for new input is expressed using a regression method through mapping of input variables by a kernel function. Also, there is an important property that a final output (expectation) of the KRR model and a mean prediction output of a Gaussian process model, defined with the same kernel function and the same training data, are the same. Through this, Bayesian uncertainty of a KRR model may be interpreted as being the same as a predictive variance of the Gaussian process model defined with the same kernel function and the same training data.

The Gaussian process model and the probabilistic neural network model are equivalent in terms of expressing a relationship between training data and test data (new data for prediction not used for learning) by a kernel function (covariance function). However, two algorithms differ in terms of a methodological procedure for generating an optimal model. When training a model with N pieces of training data, the Gaussian process generates a final model through a matrix operation of a kernel function matrix with a size of N×N. On the contrary, the neural network model generates a model by approximately finding an optimal solution for a differentiable objective function through a stochastic gradient descent. Due to learning characteristics of the neural network model, probability of overfitting increases as dynamic learning progresses.

FIG. 3 illustrates an example of learning dynamics from phase 0 to phase 3 of a probabilistic (Bayesian) neural network model according to an example embodiment. The example embodiment shows an output distribution for each training process when a probabilistic neural network for classification is treated as a single neural network model that output uncertainty (scalar) of data. In a process of training (generating) the neural network model, characteristics of the model may be divided into four phases from phase 0 to phase 3 according to a phase in which a single learning unit (epoch) progresses.

Phase 0 refers to a neural network model in an initial state of learning and, here, both training data (data area indicated with dots) and test data show high average data uncertainty (aleatoric uncertainty, final output of the model). A shaded part refers to a variance of output and represents a meaningful range in which an output value is possible depending on a sampled parameter and, at the same time, represents Bayesian uncertainty (epistemic uncertainty) of the model. That is, in phase 0, uncertainty of data itself and uncertainty of the model are high in most areas.

In phase 1, as training progresses, the uncertainty of data that is an output of the neural network appears close to a true value and the uncertainty of the model also arises in all areas. However, the model uncertainty over training data relatively decreases.

Phase 2 refers to a theoretical well-fitting state. When training theoretically progresses, the model uncertainty of training data decreases to 0 and only model uncertainty for test data is measured. However, in reality, phase 3 that represents overfitting proceeds without going through phase 2 and thus, phase 2 may be a virtual state.

In phase 3, overfitting occurs and uncertainty of training data approaches zero since, as training progresses, overfitting occurs in training data itself and entropy is not measured.

Then, that phase 1 is a most appropriate state for training a proxy Gaussian process model is described. In a realistic scenario, phase 1 may be regarded as a training state before overfitting occurs. Here, model uncertainty of training data observed is referred to as epistemic noise. When defining the Gaussian process model, training data may be regarded as data sampled from a population function (original function) to be restored using Bayesian methodology. Here, since it is assumed that random noise from actual output of an original function is added to a label of training data, the Gaussian process may be understood as an algorithm that probabilistically models the original function considering random noise. From this point of view, the epistemic noise of the probabilistic neural network may correspond to noise of training data in the proxy Gaussian process model and this substitution may generate the proxy Gaussian process model capable of best approximating uncertainty of an original Bayesian neural network. Since training data and test data are sampled from the same distribution, the average output distribution of the original Bayesian neural network model for the training data and the test data appears similar in phase 1. However, as in phase 3, the output average for two datasets varies in a model with overfitting. Therefore, in a phase beyond phase 1, the proxy Gaussian process model trained using a dataset (e.g., training dataset D* 130) generated with training data and an output value thereof has difficulty in correctly approximating the uncertainty of the original neural network for test data.

Although the present invention may be directly applied to various types of neural network models, representative four example embodiments are described with reference to the accompanying drawings.

### Verification of Prediction Accuracy of Classification Neural Network

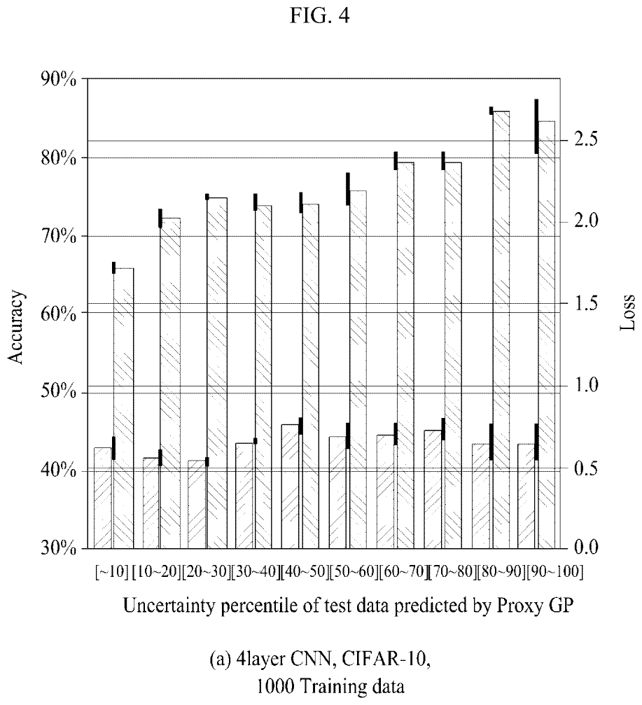

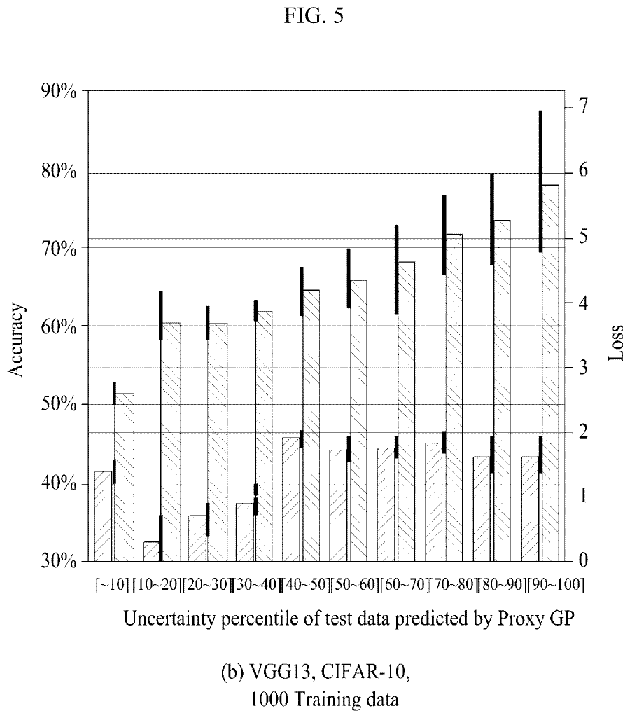

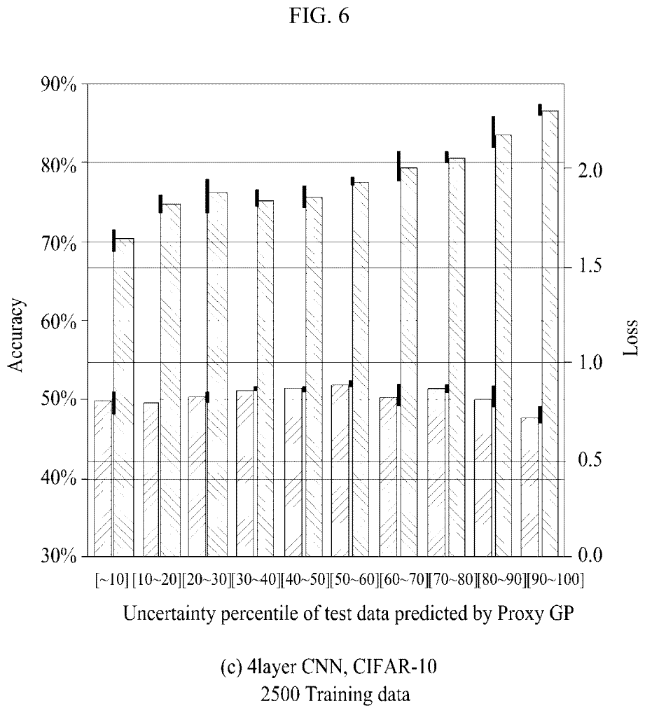

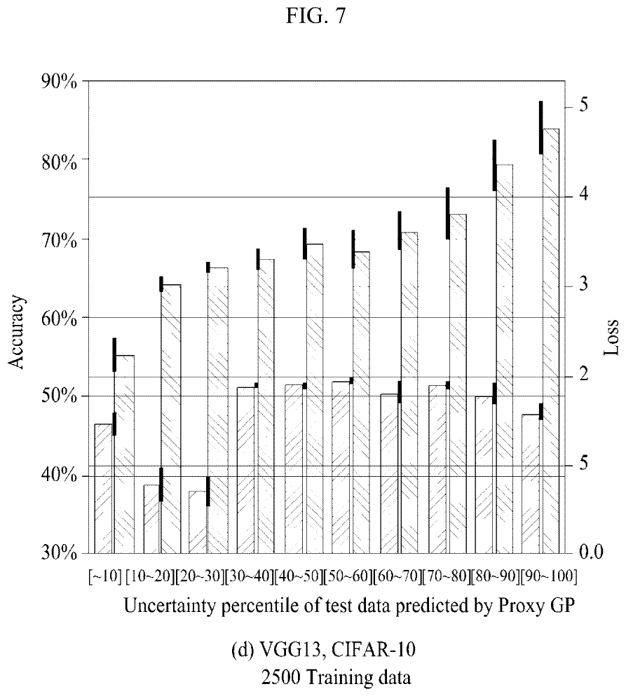

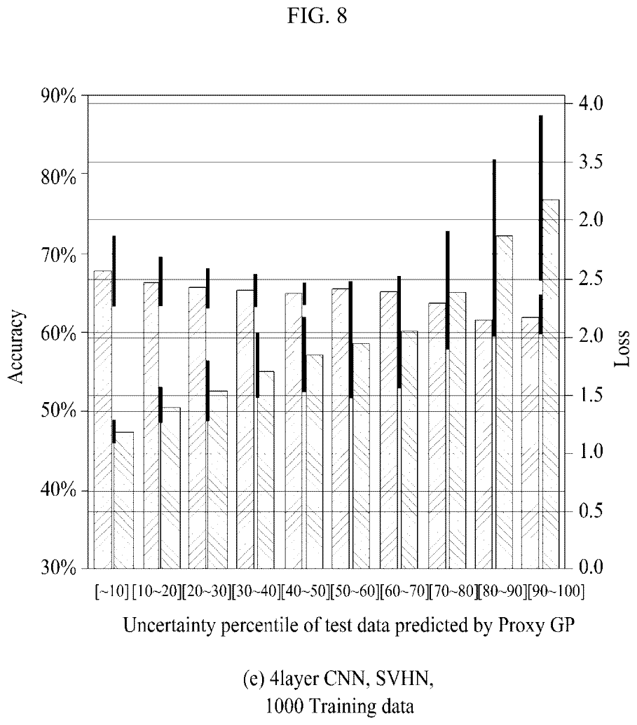

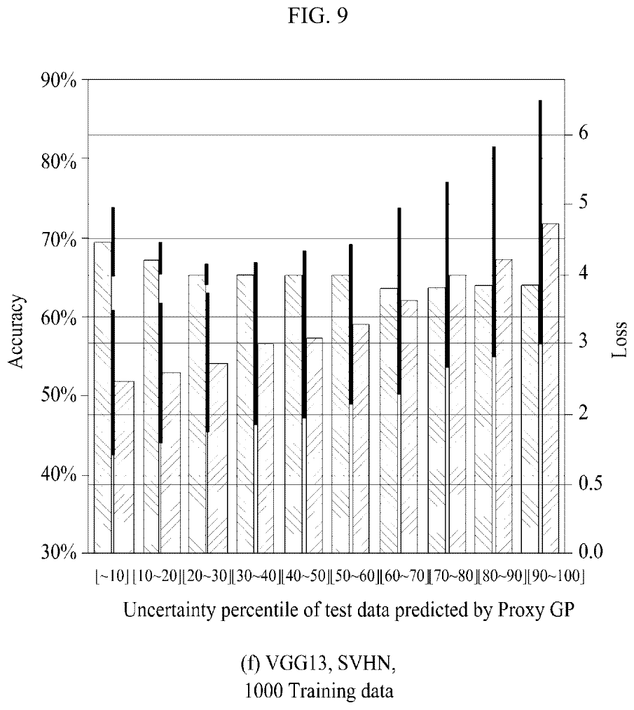

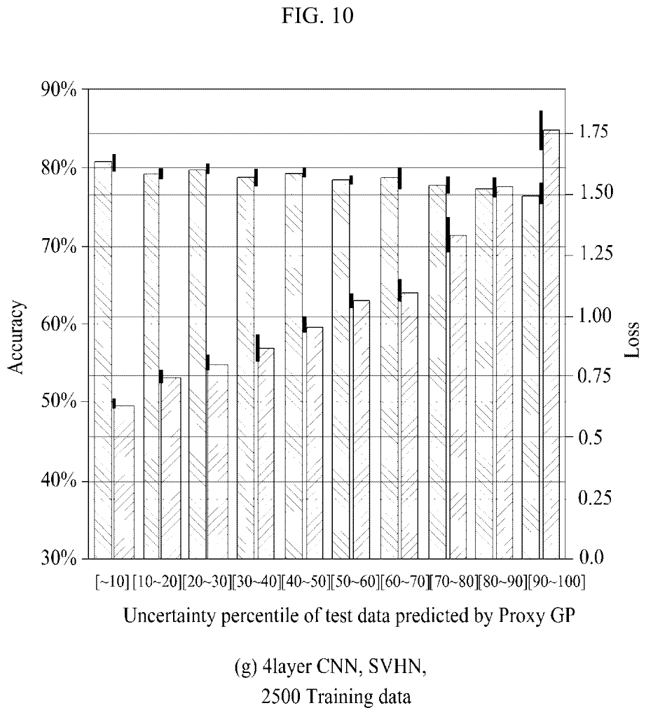

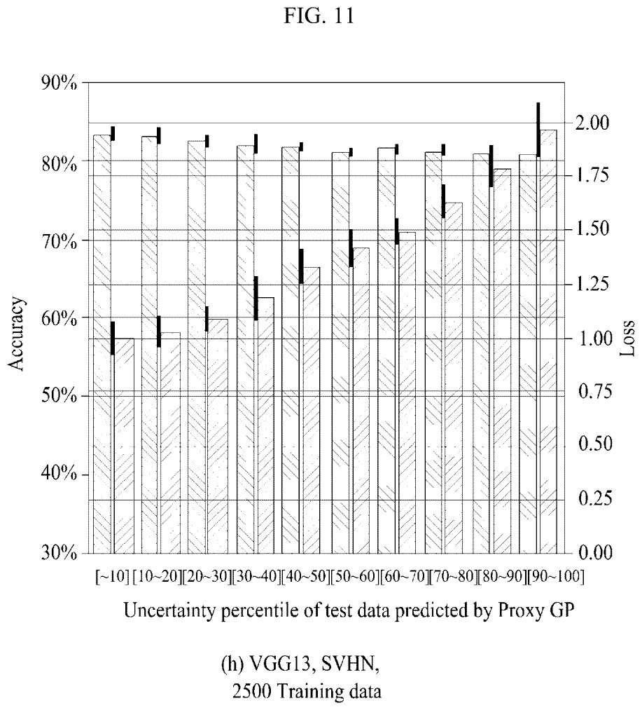

FIGS. 4 to 11 are graphs showing examples of actual error (loss) and accuracy in an original convolutional neural network (CNN) model of test data according to prediction uncertainty of a Gaussian process model generated by a deterministic CNN model according to an example embodiment. VGG13 and 4 layer CNN models were trained using 1,000 and 2,500 training datasets randomly selected from SVHN dataset and CIFAR10 dataset, respectively (a total of 2×2×2=8 models are generated). A proxy Gaussian process model was generated for each model and uncertainty for an original neural network model was estimated by inputting a test dataset to the Gaussian process model. The test dataset was reclassified by being arranged in ascending order based on the estimated uncertainty and by being divided into ten groups based on a 10% unit. An average loss and an average accuracy acquired by inputting reclassified detailed test datasets of 10 groups to the original neural network model and by comparing the same with answer. As a result, as shown in graphs of FIGS. 4 to 11, as the uncertainty is predicted to be higher, the tendency that loss increases and accuracy decreases clearly appears.

### Verification of Prediction Accuracy of Regressive Neural Network

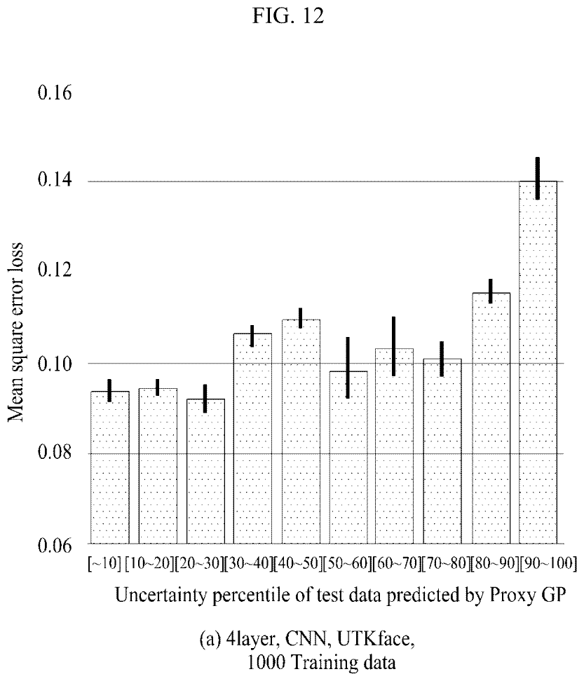

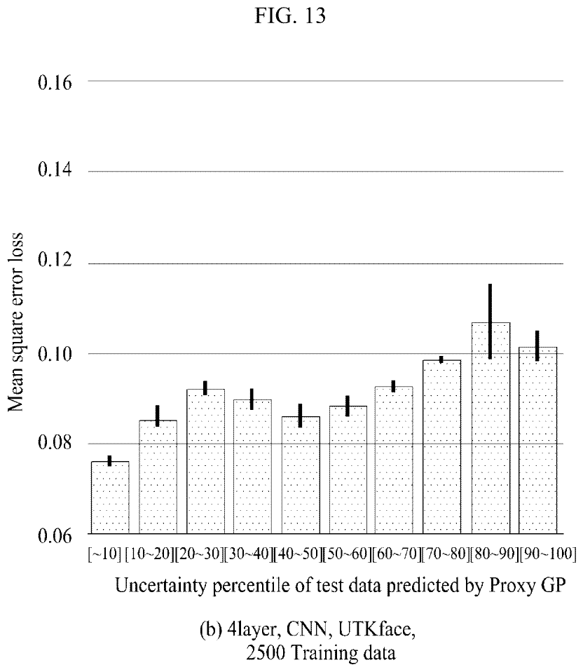

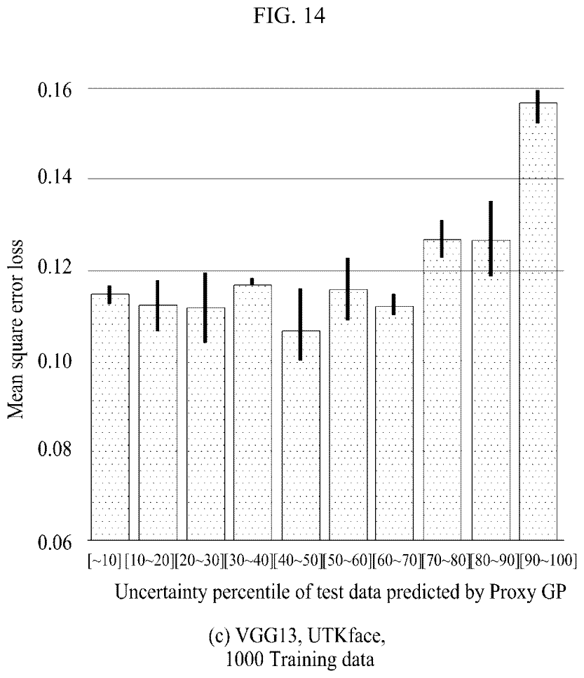

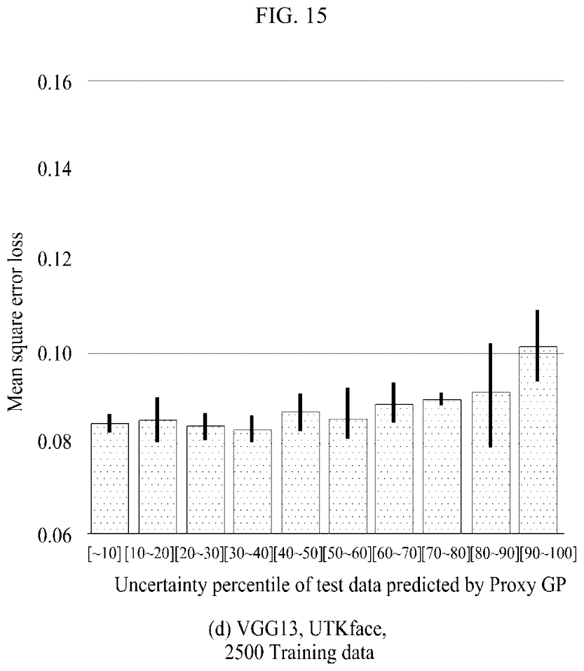

FIGS. 12 to 15 are graphs showing examples of actual error (loss) in an original CNN model of test data according to prediction uncertainty of a Gaussian process model generated by a deterministic CNN regression model according to an example embodiment.

VGG13 and 4 layer CNN regression models (one output unit) were trained using 1,000 and 2,500 training datasets randomly selected from UTKface dataset (label is an age of a person) (a total of 2×2=4 models are generated). A proxy Gaussian process model was generated for each model and uncertainty of an original neural network model was estimated by inputting a test dataset to the Gaussian process model. The test dataset was reclassified by being arranged in ascending order based on the estimated uncertainty and by being divided into 10 groups based on a 10% unit. An average loss and an average accuracy acquired by inputting the reclassified detailed test datasets of 10 groups to the original neural network model and by comparing the same with answer. As a result, as shown in graphs of FIGS. 12 to 15, as the uncertainty is predicted to be higher, the tendency that loss increases clearly appears.

### Active Learning

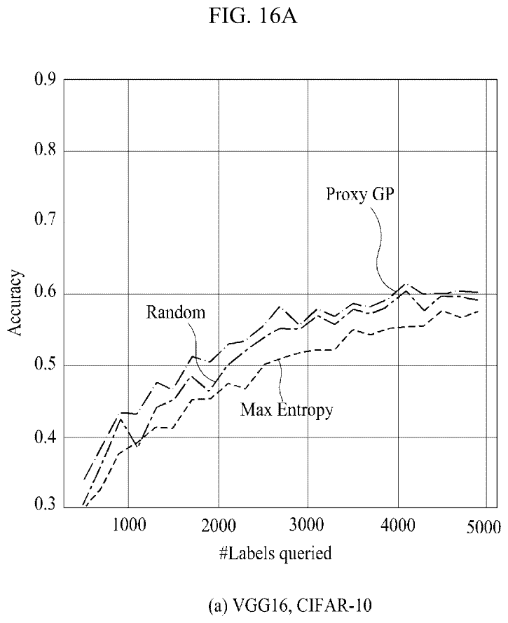

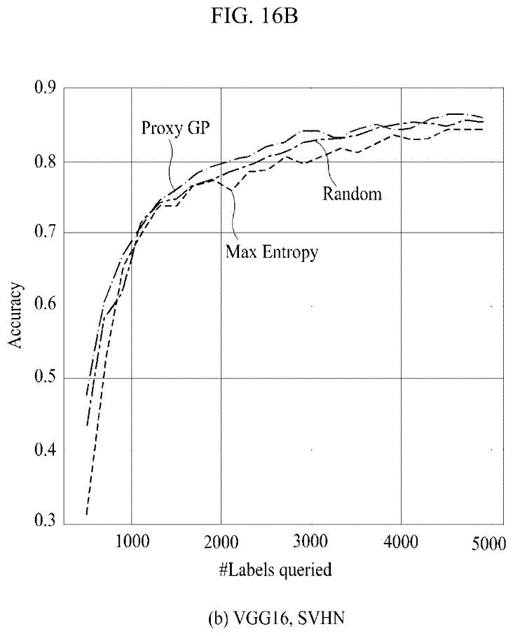

FIG. 16 is a graph showing an example of comparing active learning that selects training data according to prediction uncertainty of a Gaussian process model generated by a deterministic CNN model and active learning that selects the training data according to other algorithms according to an example embodiment. VGG16 model was generated by randomly selecting 500 pieces of initial training data from each of SVHN dataset and CIFAR10 dataset (a total of two models are generated). A proxy Gaussian process model was generated for each model and uncertainty of an original neural network model was estimated by inputting a remaining candidate training dataset to the Gaussian process model. Active learning was performed by repeatedly adding 200 pieces of training data predicted with the highest uncertainty to a learning pool. When active learning was performed according to example embodiments, significantly high active learning performance was achieved compared to when active learning was performed according to other active learning algorithms.

### Application in a Generative Model

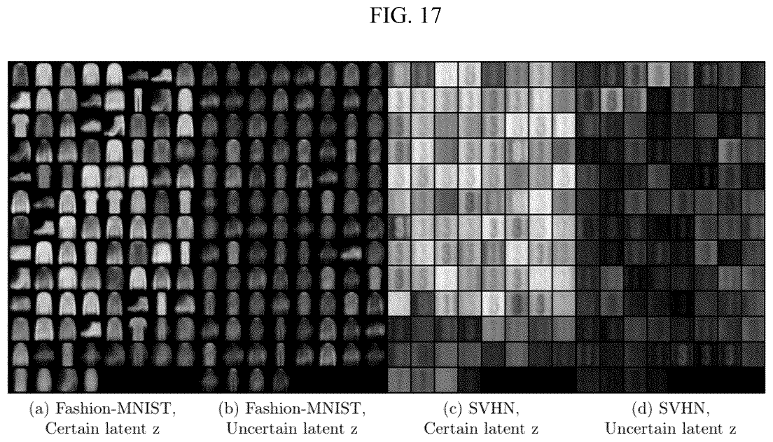

FIG. 17 illustrates an example of comparing a latent vector extracted by a deterministic variational autoencoder (VAE) generation model and an image generation result according to prediction uncertainty of a Gaussian process model of an original VAE model according to an example embodiment. A VAE that is a generative model including four hidden layers was implemented and a partial model from a hidden layer that extracts a latent noise vector to a final output layer was approximated with a proxy Gaussian process. As a result of extracting random noise from the original VAE model and inputting the same to the proxy Gaussian process model, a blurred image and a clear image were generated in a vector with high uncertainty and a vector with low uncertainty, respectively. That is, it is shown that even the generative model may estimate uncertainty of noise for generating an image using the proxy Gaussian process model.

The example embodiments may have the following features:
Meta model: A model that re-approximates a model generated for statistical prediction, such as machine learning, is referred to as a meta model. The example embodiments relate to original methodology that is approached through the meta model to approximate uncertainty of an original model. In addition, the example embodiments relate to original methodology that estimates hidden uncertainty of an original neural network within a reasonable range by approximating a deterministic neural network model that is difficult to directly measure uncertainty, with a probabilistic model.
Scalability to a general neural network model: The example embodiments may be applied to various types of deterministic neural network models, such as a regression neural network, a generative model, and the like, as well as a classification neural network used as an example and, thus may have extensive scalability.
Convenience of operation: The example embodiments do not require additional structural modification to an original neural network to estimate uncertainty of a neural network and thus, may not interfere with a unique functional design of a neural network model. In addition, the example embodiments may be implemented only with data used for training of the original neural network model and thus, may have high practical convenience.

Meanwhile, the neural network model forms the basis of a modern artificial intelligence (AI) system and its scope of application extends to areas that directly deal with human life. For example, an autonomous vehicle or a medical diagnosis system may require a very immediate intervention of artificial intelligence, but an erroneous judgement or prediction may cause fatal errors due to characteristics of the AI system. If the reliability of the prediction or the judgement is capable of being expressed in a form of uncertainty, an opportunity may be secured to suspend execution by the judgement of AI or to request a secondary judgement from a more trustworthy subject. In this aspect, verifying the uncertainty of the AI system is a very important issue. However, if uncertainty estimation is difficult or if a lot of cost is required, the development cost of AI may be greatly streamlined by alleviating the issue. Also, a baseline for determining domain knowledge to be learned under limited learning resources to improve the AI system may be found from the uncertainty. In an expert area in which a lot of cost is required to secure training data, great contribution may be made in terms of reduction in cost and development time.

Most AI system services may be performed by providing a response (Y) to an appropriate request (input X) of a customer. If an internal operating characteristic of the corresponding AI system can be known in a form of uncertainty by acquiring request and response information, an internal operation of a counterpart system may be reverse engineered. The principle proposed in the example embodiments may be widely used for improvement of security and diagnosis of the AI system.

A method and system for estimating output uncertainty of a deterministic ANN according to example embodiments may be employed in the following fields.

Medical field: When a general doctor reads a medical image or interprets other medical data with the help of an AI system that assists medical image interpretation in an emergency room that is in urgent need or in a medical institution with lacking radiologists, the example embodiments may be used to determine whether to accept judgment of the AI system as is and apply the same to medical treatment or whether to request a secondary interpretation from a specialist. The example embodiments may be applied to establishing other treatment plans in the same manner.

Autonomous transportation system: Through estimation of uncertainty, it is possible to quickly determine the extent to which human intervention is to be requested in an area in which safety judgement is required in a transportation system that may not be fully determined by the AI system. In addition, when training data is acquired through situation exploration, the example embodiments may be applied to determine an optimal direction and location of exploration.

Development of AI solution: When a company that develops an AI system itself, such as a real-time AI service, purchases training data to improve performance of a model, data to be purchased in a limited budget environment may be determined.

Expert system field: Example embodiments may be applied to route path optimization of a reinforcement learning system and development of any types of AI systems that learn or determine expert knowledge.

All fields that require human-AI interaction: Reliable tasks may be achieved in a short period of time by potentially employing the example embodiments in a field in which a user and an AI system need to constantly interact, for example, brain-based AI.

An output uncertainty estimation system of a deterministic ANN according to example embodiments may be implemented by at least one computer device and an output uncertainty estimation method according to example embodiments may be performed through at least one computer device included in the output uncertainty estimation system. A computer program according to an example embodiment may be installed and executed on the computer device and the computer device may perform the output uncertainty estimation method according to example embodiments under control of the executed computer program. The computer program may be stored in a computer-readable recording medium to execute the output uncertainty estimation method on the computer device in conjunction with the computer device.

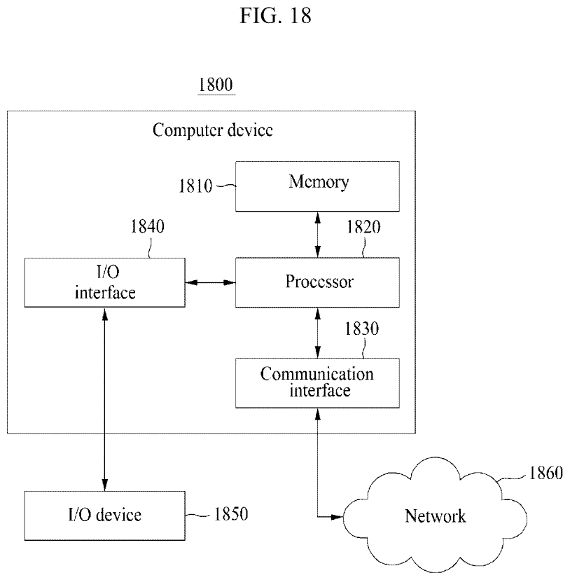

FIG. 18 is a block diagram illustrating an example of a computer device according to an example embodiment. Referring to FIG. 18, a computer device 1800 may include a memory 1810, a processor 1820, a communication interface 1830, and an input/output (I/O) interface 1840. The memory 1810 may include a permanent mass storage device, such as a random access memory (RAM), a read only memory (ROM), and a disk drive, as a non-transitory computer-readable record medium. The permanent mass storage device, such as ROM and a disk drive, may be included in the computer device 1800 as a permanent storage device separate from the memory 1810. Also, an OS and at least one program code may be stored in the memory 1810. Such software components may be loaded to the memory 1810 from another non-transitory computer-readable record medium separate from the memory 1810. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 1810 through the communication interface 1830, instead of the non-transitory computer-readable record medium. For example, the software components may be loaded to the memory 1810 of the computer device 1800 based on a computer program installed by files received over a network 1860.

The processor 1820 may be configured to process instructions of a computer program by performing basic arithmetic operations, logic operations, and I/O operations. The computer-readable instructions may be provided from the memory 1810 or the communication interface 1830 to the processor 1820. For example, the processor 1820 may be configured to execute received instructions in response to the program code stored in the storage device, such as the memory 1810.

The communication interface 1830 may provide a function for communication between the communication system 1800 and another device over the network 1860. For example, the processor 1820 of the computer device 1800 may forward a request or an instruction created based on a program code stored in the storage device such as the memory 1810, data, and a file, to other devices over the network 1860 under control of the communication interface 1830. Inversely, a signal, an instruction, data, a file, etc., from another device may be received at the computer device 1800 through the communication interface 1830 of the computer device 1800 over the network 1860. For example, a signal, an instruction, data, etc., received through the communication interface 1830 may be forwarded to the processor 1820 or the memory 1810, and a file, etc., may be stored in a storage medium, for example, the permanent storage device, further includable in the computer device 1800.

The I/O interface 1840 may be a device used for interfacing with an I/O device 1850. For example, an input device may include a device, such as a microphone, a keyboard, a mouse, etc., and an output device may include a device, such as a display, a speaker, etc. As another example, the I/O interface 1840 may be a device for interfacing with a device in which an input function and an output function are integrated into a single function, such as a touchscreen. The I/O device 1850 may be configured as a single device with the computer device 1800.

According to other example embodiments, the computer device 1800 may include the number of components greater than or less than the number of components shown in FIG. 18. However, there is no need to clearly illustrate many components according to the related art. For example, the computer device 1800 may include at least a portion of the I/O device 1850, or may further include other components, for example, a transceiver, a database, etc.

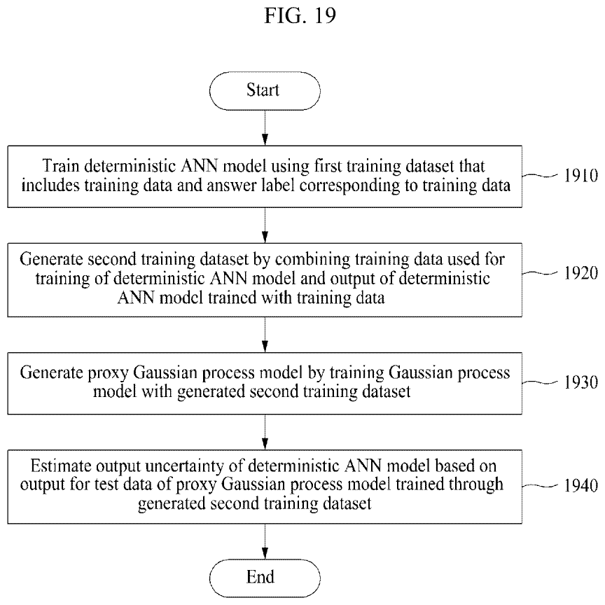

FIG. 19 is a flowchart illustrating an example of an output uncertainty estimation method according to an example embodiment. The output uncertainty estimation method according to an example embodiment may be performed by the computer device 1800 of FIG. 18. Here, the processor 1820 of the computer device 1800 may be configured to execute a control instruction according to a code of at least one computer program or a code of an OS included in the memory 1810. Here, the processor 1820 may control the computer device 1800 to perform operations 1910 to 1940 included in the method of FIG. 19.

In operation 1910, the computer device 1800 may train a deterministic ANN model using a first training dataset that includes training data and an answer label corresponding to the training data. Here, the deterministic ANN model may include at least one of a classification neural network, a regression neural network, and a generative model.

In operation 1920, the computer device 1800 may generate a second training dataset by combining training data used for training of the deterministic ANN model and output of the deterministic ANN model trained with the training data. In this case, the computer device 1800 may generate the second training dataset that includes the output of the trained deterministic ANN model by matching the same with the training data as a temporary output label. Here, when the training data includes image data, the computer device 1800 may transform the training data in a form of a matrix to an input in a form of a low-dimensional vector for the proxy Gaussian process model. For example, the computer device 1800 may transform the training data for training the proxy Gaussian process model to a feature vector extracted from an intermediate hidden layer of the deterministic ANN model for the training data. Also, when an output layer of the deterministic ANN model includes a plurality of units, the computer device 1800 may integrate output of a plurality of categories of the deterministic ANN model into one scalar. In this case, the computer device 1800 may integrate, into one scalar, the output of the plurality of categories of the deterministic ANN model by transforming the output of the deterministic ANN model from a vector expressed through a softmax function to entropy that is a one-dimensional unit value.

In operation 1930, the computer device 1800 may generate the proxy Gaussian process model by training a Gaussian process model with the generated second training dataset. That is, the deterministic ANN model may be trained using the first training dataset that includes the training data and the answer label, and the proxy Gaussian process model may be trained using the second training dataset that includes the training data and a label as the output of the trained deterministic ANN model.

In operation 1940, the computer device 1800 may estimate output uncertainty of the deterministic ANN model based on output for test data of the proxy Gaussian process model trained through the generated second training dataset. In an example embodiment, the computer device 1800 may estimate a predictive variance output from the proxy Gaussian process model as the output uncertainty of the deterministic ANN model. As described above, the variance may be determined through approximation to the output uncertainty of the deterministic ANN model based on equivalence between a Gaussian process model and a probabilistic neural network model and a Bayesian interpretation of a KRR algorithm. Therefore, the computer device 1800 may estimate the output uncertainty of the deterministic ANN model based on the output for the test data of the proxy Gaussian process model without modifying a structure of the deterministic ANN model.

As described above, according to example embodiments, it is possible to indirectly estimate uncertainty of output inherent in a deterministic ANN, which is most widely used in a machine learning task, using a Gaussian process model. Also, it is possible to contribute to increasing trust of general consumers on an AI system and also expected to positively contribute to expansion of a related market by promoting research and development related to estimation of uncertainty of a neural network.

The systems and/or the apparatuses described herein may be implemented using hardware components, software components, and/or combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of the media include magnetic media, such as hard disks, floppy disks, and magnetic tapes; optical media, such as CD ROM disks and DVDs; magneto-optical media, such as floptical disks; and hardware devices that are specially to store and perform program instructions, such as read-only memory (ROM), random access memory (RAM), flash memory, and the like. Examples of other media may include record media and storage media managed by an app store that distributes applications or a site that supplies and distributes other various types of software, a server, and the like. Examples of the program instructions include a machine language code as produced by a compiler and an advanced language code executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. An output uncertainty estimation method of a computer device including at least one processor, the output uncertainty estimation method comprising:
generating, by the at least one processor, a dataset by combining training data used for training of a deterministic artificial neural network (ANN) model and output of the deterministic ANN model trained with the training data; and
estimating, by the at least one processor, output uncertainty of the deterministic ANN model based on output for test data of a proxy Gaussian process model trained through the generated dataset.

2. The output uncertainty estimation method of claim 1, wherein the estimating comprises estimating a predictive variance output from the proxy Gaussian process model as the output uncertainty of the deterministic ANN model.

3. The output uncertainty estimation method of claim 2, wherein the variance is determined through approximation to the output uncertainty of the deterministic ANN model based on equivalence between a Gaussian process model and a probabilistic neural network model and a Bayesian interpretation of a kernel ridge regression (KRR) algorithm.

4. The output uncertainty estimation method of claim 1, further comprising:
training, by the at least one processor, the deterministic ANN model using a first training dataset that includes the training data and an answer label corresponding to the training data.

5. The output uncertainty estimation method of claim 4, wherein the generating of the dataset comprises generating a second training dataset that includes the output of the trained deterministic ANN model by matching the same with the training data as a temporary output label.

6. The output uncertainty estimation method of claim 1, further comprising:
generating, by the at least one processor, the proxy Gaussian process model by training a Gaussian process model with the generated dataset.

7. The output uncertainty estimation method of claim 1, wherein the generating of the dataset comprises transforming the training data in a form of a matrix to an input in a form of a low-dimensional vector for the proxy Gaussian process model when the training data includes image data.

8. The output uncertainty estimation method of claim 7, wherein the transforming to the input comprises transforming the training data for training the proxy Gaussian process model to a feature vector extracted from an intermediate hidden layer of the deterministic ANN model for the training data.

9. The output uncertainty estimation method of claim 1, wherein the generating of the dataset comprises integrating output of a plurality of categories of the deterministic ANN model into one scalar when an output layer of the deterministic ANN model includes a plurality of units.

10. The output uncertainty estimation method of claim 9, wherein the integrating comprises integrating, into one scalar, the output of the plurality of categories of the deterministic ANN model by transforming the output of the deterministic ANN model from a vector expressed through a softmax function to entropy that is a one-dimensional unit value.

11. The output uncertainty estimation method of claim 1, wherein the deterministic ANN model includes at least one of a classification neural network, a regression neural network, and a generative model.

12. The output uncertainty estimation method of claim 1, wherein the estimating comprises estimating the output uncertainty of the deterministic ANN model based on the output for the test data of the proxy Gaussian process model without modifying a structure of the deterministic ANN model.

13. A non-transitory computer-readable recording medium storing instructions that, when executed by a processor, cause the processor to perform the method of claim 1.

14. A computer device comprising:
at least one processor configured to execute computer-readable instructions,
wherein the at least one processor is configured to
generate a dataset by combining training data used for training of a deterministic artificial neural network (ANN) model and output of the deterministic ANN model trained with the training data, and
estimate output uncertainty of the deterministic ANN model based on output for test data of a proxy Gaussian process model trained through the generated dataset.

15. The computer device of claim 14, wherein, to estimate the output uncertainty, the at least one processor is configured to estimate a predictive variance output from the proxy Gaussian process model as the output uncertainty of the deterministic ANN model.

16. The computer device of claim 15, wherein the variance is determined through approximation to the output uncertainty of the deterministic ANN model based on equivalence between a Gaussian process model and a probabilistic neural network model and a Bayesian interpretation of a kernel ridge regression (KRR) algorithm.

17. The computer device of claim 15, wherein the at least one processor is configured to train the deterministic ANN model using a first training dataset that includes the training data and an answer label corresponding to the training data.

18. The computer device of claim 17, wherein, to generate the dataset, the at least one processor is configured to generate a second training dataset that includes the output of the trained deterministic ANN model by matching the same with the training data as a temporary output label.

19. The computer device of claim 14, wherein the at least one processor is configured to generate the proxy Gaussian process model by training a Gaussian process model with the generated dataset.

20. The computer device of claim 14, wherein the at least one processor is configured to transform the training data in a form of a matrix to an input in a form of a low-dimensional vector for the proxy Gaussian process model when the training data includes image data.
